(19) United States
(12) Patent Application Publication
(10) Pub. No.: US 2010/0109326 A1
(43) Pub. Date: May 6, 2010

(54) FAN UNIT FOR WIND POWER GENERATOR AND WIND POWER GENERATOR

(76) Inventors: Shinsuke Sato, Nagasaki (JP); Toshihiro Sato, Nagasaki (JP); Shigeto Hirai, Nagasaki (JP); Tatsuya Shiraishi, Nagasaki (JP)

Correspondence Address: KANESAKA BERNER AND PARTNERS LLP, 1700 DIAGONAL RD, SUITE 310, ALEXANDRIA, VA, 22314-2848, US

(21) Appl. No.: 12/374,140

(22) PCT Filed: Nov. 10, 2008
(86) PCT No.: PCT/JP2008/070438

§ 371 Date: Jan. 16, 2009

(30) Foreign Application Priority Data
Apr. 10, 2008 (JP) 2008-102755

(51) Int. Cl. H02P 9/04

(52) U.S. Cl. 290/44

(57) ABSTRACT

To provide a fan unit for a wind power generator and a wind power generator, which are capable of preventing a loss of a flow at a flow port from increasing and capable of preventing a pressure loss of a heat exchanger from increasing. A fan unit for a wind power generator (52) having an axial fan (54) for discharging air in a nacelle of the wind power generator to a rear side of the nacelle, the axial fan (54) being provided on a floor (F) of the nacelle, and an equipment (51) of the wind power generator provided in front of the axial fan (54) in a direction of a rotation axis (L) is characterized by including a rectification part (56) for adjusting distribution of the flow rate of air flowing into the axial fan (54).

### TECHNICAL FIELD

The present invention relates to a fan unit for a wind power generator and a wind power generator.

### BACKGROUND ART

The range of air temperatures in which the wind power generator is operated is generally from minus 30 degrees centigrade to plus 40 degrees centigrade. Accordingly, it is necessary to control the temperature of the internal equipment of the wind power generator such as main bearings, a speed increasing gear, a generator, a transformer and an inverter, for example, to within a range of the standard temperature.

In order to perform such temperature control, an oil piping system for a vane pitch system, the speed increasing gear, the main bearing and the like and a cooling piping system for the inverter and the like are respectively provided with heaters and coolers as temperature control systems (refer to Patent Document 1).

The cooler is provided with a cooling fan for ventilating the cooler. Each of the heater and the cooling fan is controlled to be turned on and off based on the set temperatures.

Patent Document 1: Japanese Unexamined Patent Application, Publication No. Sho-58-065977

### DISCLOSURE OF INVENTION

A fan for ventilating a windmill and a fan for cooling the cooler fan are provided in a nacelle. This causes a problem where a pressure loss at an air intake port of the fan or a discharge port of the fan increases according to the internal structure of the nacelle or the placement of the fan, and the ventilation performance and the cooling performance can not be sufficiently exerted.

Specifically, the flow of the air is asymmetrical to the rotation axis of the fan when the internal components of the nacelle are placed to obstruct the air flow into the fan. This causes a problem where a pressure loss at an air flow port of the fan is increased.

In the case where a heat exchanger is mounted to the fan such as with the cooling fan, the flow of the air flowing into the fan is asymmetrical, and is uneven. This causes a problem where a pressure loss at the heat exchanger increases.

Further, in the case of discharging the air to the rear side of the nacelle by means of the fan, there is a problem where an external wind flowing outside the nacelle influences the flow of the air flowing into the fan, and the ventilation performance and the cooling performance can not be sufficiently exerted.

In other words, the influence of the external wind around the nacelle causes back pressure on the rear side of the nacelle, and the back pressure varies according to the changes of the external wind speed. Such variation of the back pressure causes a change of an operation point of the fan and the amount of fan wind changes. Accordingly, air flowing into the fan is affected, which causes a problem where the ventilation performance and the cooling performance can not be sufficiently exerted.

The invention is to solve such problems. An object of the invention is to provide a fan unit for a wind power generator and a wind power generator, which are capable of preventing a loss of flow at a flowing port from increasing and capable of preventing a pressure loss of a heat exchanger from increasing.

In order to achieve the object, the invention provides the following means.

In accordance with the first aspect of the invention, provided is a fan unit for a wind power generator having an axial fan for discharging air in a nacelle of the wind power generator to the rear side of the nacelle, the axial fan being provided on a floor of the nacelle, and an equipment of the wind power generator provided in front of the axial fan in a direction of a rotation axis, the fan unit for a wind power generator comprising a rectification part for adjusting distribution of a flow rate of air flowing into the axial fan.

In accordance with the first aspect of the invention, a rectification part adjusts distribution of the flow rate of the air detouring around an equipment of the wind power generator to flow into the axial fan. This allows a pressure loss at an air intake port or a discharge port of the axial fan to be prevented from increasing. Especially, the pressure loss at an air intake port or a discharge port of the axial fan can be prevented from increasing by adjusting the distribution of the flow rate of the air so as to be symmetrical to the rotation axis of the axial fan.

On the other hand, in the case of guiding the air to be sent by means of the axial fan to the heat exchanger, a pressure loss of the heat exchanger is prevented from increasing since the distribution of the flow rate of the air has been adjusted.

In the first aspect of the invention, a structure in which plural flow speed sensors for measuring a flow speed of the air flowing into the axial fan are provided and the rectification part adjusts the distribution of the flow rate of the air on the basis of the flow speed of the air measured by means of the flow speed sensors, is preferable.

In accordance with such a structure, measuring the speed of a flow of the air at plural places allows the distribution of the flow rate of the air flowing into the axial fan to be estimated. Accordingly, controlling the rectification part on the basis of the measured speed of the flow of the air can surely prevent a pressure loss at the air intake port or the discharge port of the axial fan from increasing.

In the above structure, it is preferable that the rectification part is a bell mouth and is provided movably in the direction of the rotation axis of the axial fan.

In accordance with such a structure, changing the location of the bell mouth in the direction of the rotation axis allows the distribution of the flow rate of the air flowing into the axial fan to be adjusted.

In the above structure, it is preferable that the rectification part is a guide for guiding air to the axial fan and is provided movably in the direction of the rotation axis of the axial fan.

In accordance with such a structure, changing the location of the guide in the direction of the rotation axis allows the distribution of the flow rate of the air flowing into the axial fan to be adjusted.

In the above structure, it is preferable that a first perforated plate provided with holes having approximately the same diameter, the holes evenly distributed, and a second perforated plate provided with holes gradually increasing in diameter in one direction are provided in the rectification part and the first perforated plate and the second perforated plate relatively move to adjust the distribution of the flow rate of the air flowing into the axial fan.

In accordance with such a structure, moving the first perforated plate and the second perforated plate relatively allows the area of overlap between holes of the first perforated plate and holes of the second perforated plate to be adjusted to adjust the distribution of the flow rate of the air flowing into the axial fan.

In the second aspect of the invention, provided is a wind power generator provided in a nacelle with the fan unit for a wind power generator according to the invention.

In accordance with the second aspect of the invention, a rectification part adjusts distribution of the flow rate of the air detouring around an equipment of the wind power generator to flow into the axial fan. This allows a pressure loss at an air intake port or a discharge port of the axial fan to be prevented from increasing. Especially, the pressure loss at the air intake port or the discharge port of the axial fan can be prevented from increasing by adjusting the distribution of the flow rate of the air so as to be symmetrical to the rotation axis of the axial fan.

On the other hand, in the case of guiding the air to be sent by means of the axial fan to the heat exchanger, a pressure loss of the heat exchanger is prevented from increasing since the distribution of the flow rate of the air has been adjusted.

According to the fan unit for a wind power generator in accordance with the first aspect of the invention and the wind power generator in accordance with the second aspect, a rectification part adjusts distribution of the flow rate. This allows both of the advantages where a loss of flow at a flowing port can be prevented from increasing and that a pressure loss of the heat exchanger can be prevented from increasing to be achieved.

### BRIEF DESCRIPTION OF DRAWINGS

FIG. 1 illustrates an overall structure of a wind power generator in accordance with the first embodiment of the invention.

FIG. 2 is a simplified view of a structure showing the inside of a nacelle in FIG. 1.

FIG. 3 is a simplified view of a structure of a fan unit for a converter in FIG. 2.

FIG. 4 is a block diagram illustrating a structure of a fan unit for a converter in FIG. 2.

FIG. 5 is a simplified view of a fan unit for a converter in FIG. 3 in accordance with another embodiment.

FIG. 6 is a simplified view of a fan unit for a converter in FIG. 3 in accordance with further another embodiment.

FIG. 7 is a simplified view of a fan unit for a converter in FIG. 3 in accordance with further another embodiment.

FIG. 8 is a simplified view of a structure of a fan unit for a converter in a wind power generator in accordance with a second embodiment of the invention.

FIG. 9 is a partially enlarged view of a structure of a first perforated plate in FIG. 8.

FIG. 10 is a partially enlarged view of a structure of a second perforated plate in FIG. 8.

FIG. 11 is a block diagram illustrating a structure of a fan unit for a converter in FIG. 8.

FIG. 12 is a simplified view of a structure of a fan unit for a converter in a wind power generator in accordance with a third embodiment of the invention.

### EXPLANATION OR REFERENCES

1, 401: WIND POWER GENERATOR
3: NACELLE
7: GENERATION DEVICES (EQUIPMENT)
51: CONVERTER MAIN BODY (EQUIPMENT)
52, 452: FAN UNIT FOR CONVERTER (FAN UNIT FOR WIND POWER GENERATOR)
54: FAN FOR CONVERTER (AXIAL FAN)
56: BELL MOUTH (RECTIFICATION PART)
156, 256: GUIDE (RECTIFICATION PART)
356: DUCT (RECTIFICATION PART)
456A: FIRST PERFORATED PLATE (RECTIFICATION PART)
456B: SECOND PERFORATED PLATE (RECTIFICATION PART)
461A: FIRST HOLE (OPENING)
461B: SECOND HOLE (OPENING)
556: EXFOLIATION PREVENTION GUIDE (RECTIFICATION PART)

### BEST MODE FOR CARRYING OUT THE INVENTION

### First Embodiment

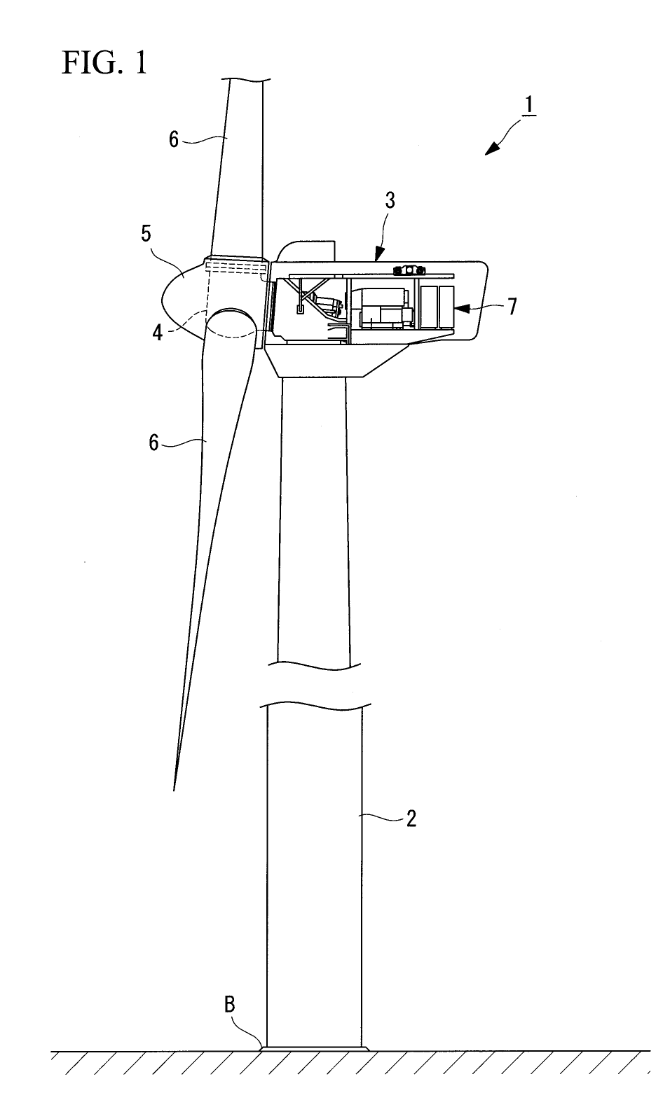

A wind power generator in accordance with the First Embodiment of the invention will be described hereinafter, with references to FIGS. 1 to 7.

FIG. 1 illustrates an overall structure of a wind power generator in accordance with First Embodiment.

A wind power generator 1 is for generating wind power, as shown in FIG. 1. The wind power generator 1 comprises a support 2 erected on a base B, a nacelle 3 provided at the top end of the support 2, a rotor head 4 mounted to the nacelle 3 so as to be rotatable about a substantially horizontal axis, a head capsule 5 for covering the rotor head 4, plural windmill rotation vanes 6 radially mounted around the rotation axis of the rotor head 4 and generation devices (equipment) 7 for generating electricity in accordance with a rotation of the rotor head 4.

In First Embodiment, exemplified will be a case in which three windmill rotation vanes 6 are provided. The number of the windmill rotation vanes 6, however, is not limited to three, but may be two or a number more than three. It is not specifically limited.

The support 2 is arranged to be in the shape of a pillar extending upward (to an upper side of FIG. 1) from the base B, as shown in FIG. 1. The support 2 is arranged to comprise multiple units connected in the vertical direction, for example. At an uppermost part of the support 2, provided is the nacelle 3. The nacelle 3 is provided on a unit provided at the uppermost part in the case that the support 2 is formed from multiple units.

The nacelle 3 rotatably supports the rotor head 4 and contains therein the generation devices 7 for generating electricity in accordance with a rotation of the rotor head 4, as shown in FIG. 1. Furthermore, an air intake port 8 for introducing the external air into the inside of the nacelle 3 is provided in a front part of the nacelle 3, namely in a lower part of the nacelle 3 on a rotor head 4 side.

To the rotor head 4, mounted are the plural windmill rotation vanes 6 extending radially about the rotation axis of the rotor head 4, as shown in FIG. 1. The head capsule 5 covers the rotor head 4.

The rotor head 4 is provided with a pitch control part (not shown) for rotating the windmill rotation vanes 6 about an axis of the windmill rotation vanes 6 to change a pitch angle of the windmill rotation vanes 6.

This allows the windmill rotation vanes 6 to generate power for rotating the rotor head 4 about the rotation axis when the wind strikes the windmill rotation vanes 6 from a direction of the rotation axis of the rotor head 4, so that the rotor head 4 is driven to rotate.

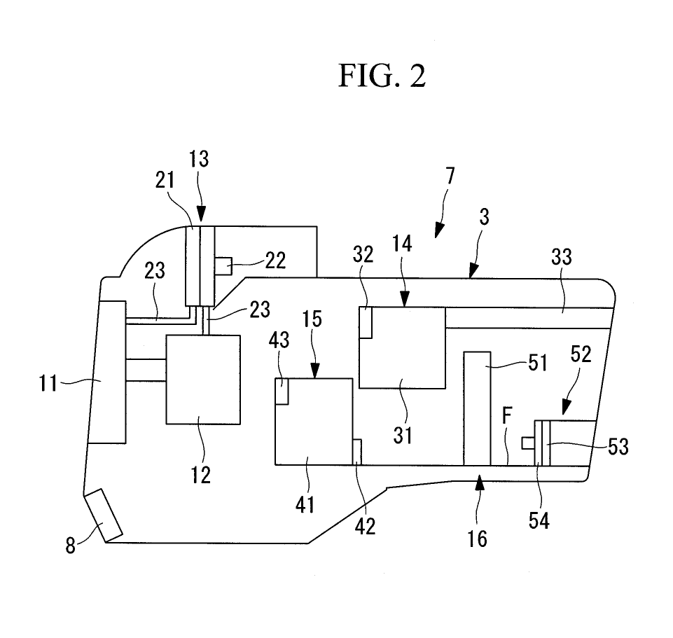

FIG. 2 is a simplified view of a structure showing the inside of a nacelle in FIG. 1.

The generation devices 7 contained in the nacelle 3 are provided with main bearings 11 for rotatably holding a main shaft (not shown) transmitting rotational driving force of the rotor head 4 to a generator 14, a speed increasing gear 12 for increasing a speed of a rotation of the rotor head 4 to transmit the same to the generator 14, an oil cooling part 13 for cooling oil used for lubricating the main bearings 11 and the speed increasing gear 12, the generator 14 for generating electricity by means of the transmitted rotational driving force, a transformer part 15 for controlling a voltage of generated electricity and a converter part 16 for controlling a frequency, as shown in FIG. 2.

The oil cooling part 13 is for lubricating the main bearings 11 and the speed increasing gear 12 and for cooling lubricating oil having a high temperature.

The oil cooling part 13 comprises an oil heat exchanger 21 for radiating heat of the lubrication oil, an oil fan 22 for ventilating the oil heat exchanger 21, an oil pipe 23 for circulating the lubricating oil between the main bearings 11 and the oil heat exchanger 21 or between the speed increasing gear 12 and the oil heat exchanger 21.

The generator 14 comprises a generator main body 31 for generating electricity, a generator fan 32 for introducing the air into the generator main body 31 and a generator duct 33 for guiding the air, which has been introduced into the generator 14, to the outside of the nacelle 3.

As the generator main body 31, the generator fan 32 and the generator duct 33, used can be well-known components, which are not specifically limited.

The transformer part 15 comprises a transformer main body 41 for converting a voltage, an opening 42 for ventilating the transformer main body 41 and a transformer fan 43.

As the transformer main body 41, the opening and the transformer fan 43, used can be well-known components, which are not specifically limited.

The converter part 16 is provided in the nacelle 3 at the rear part thereof (on the right side in FIG. 2) on a floor F of the nacelle 3.

The converter part 16 comprises a converter main body (equipment) 51 for converting a frequency and a fan unit for a converter (a fan unit for a wind power generator) 52 for cooling the converter main body 51.

The converter 51 is provided in front of the fan unit for a converter 52 (on the left side in FIG. 2) on the floor F of the nacelle 3. In other words, it is provided in front of the fan unit for a converter 52 in a direction of a rotation axis L of the fan for a converter 54.

As the converter main body 51, used can be a well-known component, which is not specifically limited.

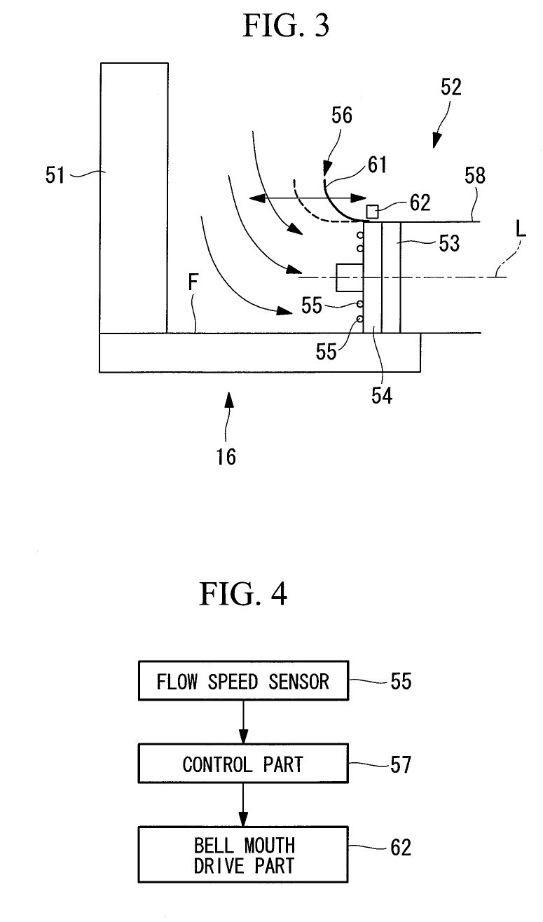

FIG. 3 is a simplified view of a structure of a fan unit for a converter in FIG. 2. FIG. 4 is a block diagram illustrating a structure of a fan unit for a converter in FIG. 2.

The fan unit for a converter 52 comprises a heat exchanger for a converter 53 in which a refrigerant for cooling the converter main body 51 circulates, the fan for a converter (the axial fan) 54 for ventilating the heat exchanger for a converter 53, plural flow speed sensors 55 for measuring a speed of a flow of the air flowing into the fan for the converter 54, a bell mouth (a rectification part) 56 for adjusting distribution of the flow rate of the air flowing into the fan for a converter 54 and a control part 57 for controlling a location where the bell mouth 56 is provided, as shown in FIGS. 3 and 4.

The refrigerant having increased in temperature by absorbing the heat generated in the converter main body 51 flows into the heat exchanger for a converter 53. The heat exchanger for a converter 53 radiates the heat of the refrigerant to the air. The heat exchanger for a converter 53 is provided on a downstream side of the fan for a converter 54 (on the left side in FIG. 3).

The heat exchanger for a converter 53 can be a known one, which is not specifically limited.

The fan for a converter 54 is an axial fan and for ventilating the heat exchanger for a converter 53 with the air for a heat exchange. In other words, it is for ventilating the heat exchanger for a converter 53 to discharge the air in the nacelle 3 to the rear side of the nacelle 3.

The fan for a converter 54 is provided with a fan for a converter 54 extending to the rear side of the nacelle 3. The fan for a converter 54 is for sending the air into a converter duct 58. Moreover, the heat exchanger for a converter 53 is provided in the converter duct 58.

The flow speed sensor 55 is a sensor, which is provided in an air flow part of the fan for a converter 54, for measuring a speed of a flow. The flow speed sensors 55 are provided so as to disperse on a surface to which the air flows.

The flow speed sensors 55 are connected to the control part 57 so that data of the measured flow speed can be transmitted, as shown in FIG. 4.

The bell mouth 56 is provided on an air flow side of the fan for a converter 54, as shown in FIG. 3, and adjusts the distribution of the flow rate of the air flowing into the fan for a converter 54.

The bell mouth 56 comprises a bell mouth main body 61, which is provided movably in a direction along the rotation axis L of the fan for a converter 54, for adjusting a flow of the air and a bell mouth drive part 62 for controlling a location where the bell mouth main body 61 is provided.

The bell mouth drive part 62 is connected to the control part 57 as shown in FIG. 4 so that a control signal for controlling the location of the bell mouth main body 61 can be inputted.

As the bell mouth and the bell mouth drive part 62, used can be well-known components, which are not specifically limited.

The control part 57 controls the bell mouth 56 on the basis of outputs from the flow speed sensors 55 to even distribution of the flow rate of the air flowing into the fan for a converter 54.

The control part 57 is connected to the flow speed sensors 55 so that the data of the flow speed detected by means of the flow speed sensors 55 would be inputted and is connected to the bell mouth drive part 62 so that the control signal would be inputted.

Now, schematically described will be a way of generating electricity in the wind power generator 1 having the above structure.

In the wind power generator 1, the force of the wind having struck the windmill rotation vanes 6 in a direction of the rotation axis of the rotor head 4 is converted into power for rotating the rotor head 4 about the rotation axis.

The rotation of the rotor head 4 is transmitted to the generation devices 7. In the generation devices 7, generated is the power corresponding to a subject of power supply, the alternated current power having the frequency of 50 Hz or 60 Hz, for example.

In this case, the nacelle 3 is properly rotated in a horizontal plane to make the rotor head 4 be directed to the wind at least during generation so that the wind power would effectively operate on the windmill rotation vanes.

Now, described will be a flow of the air in the fan unit for a converter 52, which is a character of First Embodiment.

A way of cooling the converter main body 51 will be first described. Following to the above, described will be a way of adjusting the distribution of the flow rate of the air flowing into the fan for a converter 54.

The refrigerant is circulated between the converter main body 51 and the heat exchanger for a converter 53 to let the refrigerant having absorbed heat in the converter main body 51, flow into the heat exchanger for a converter 53, as shown in FIG. 3, in order to cool the converter main body 51. The heat of the refrigerant is radiated to the air flowing around in the heat exchanger for a converter 53. The refrigerant having decreased in temperature due to radiation of the heat flows into the converter main body 51 again to absorb the heat generated in the converter main body 51.

The air sent from the nacelle 3 by means of the fan for a converter 54 flows around the heat exchanger for a converter 53 to take the heat from the refrigerant. The air having taken the heat passes through the converter duct 58 to be discharged to the rear side of the nacelle 3.

When the air in the nacelle 3 flows into the fan 54 for a converter 54, the air detours around the converter main body 51 provided in front of the fan for a converter 54, as shown in FIG. 3. In other words, the fan for a converter 54 is provided on the floor F while the converter main body 51 is provided in front of the fan for a converter 54. Accordingly, the air in the nacelle 3 flows from the upper side to the fan for a converter 54 along the converter main body 51, and the direction of the flow is changed so as to flow along the rotation axis L of the fan for a converter 54.

The flow speed of the air flowing into the fan for a converter 54 is detected by means of the plural flow speed sensors 55. The data of the flow speed is inputted to the control part 57 as shown in FIG. 4. The control part 57 estimates the distribution of the flow rate of the air on the basis of the data of the flow speed to control the bell mouth 56 based on the estimated distribution of the flow rate.

In the case that the distribution of the flow rate of the air inclines to a floor F side to be uneven, for example, outputted to the bell mouth drive part 62 is a control signal for separating the bell mouth main body 61 from the fan for a converter 54.

The bell mouth drive part 62 moves the bell mouth main body 61 to a position away from the fan for a converter 54 on the basis of the inputted control signal.

The distribution of the flow rate of the air flowing into the fan for a converter 54 is evened when the bell mouth main body 61 is moved. The loss coefficient at a flow port of the fan for a converter 54 then decreases from 1 to 0.1, for example.

In accordance with such a structure, the distribution of the flow rate of the air detouring around the converter main body 51 of the wind power generator 1 to flow into the fan for a converter 54 is adjusted by means of the bell mouth 56. This allows a pressure loss at the air intake port or the discharging port of the fan for a converter 54 to be prevented from increasing. Especially adjusting the distribution of the flow rate of the air so as to be symmetrical to the rotation axis L of the fan for a converter 54 allows a pressure loss at the air intake port or the discharging port of the fan for a converter 54 to be prevented from increasing.

On the other hand, a pressure loss of the heat exchanger for a converter 53 can be prevented from increasing since the distribution of the flow rate of the air is adjusted in the case of guiding the air sent by means of the fan for a converter 54 to the heat exchanger for a converter 53.

Measuring the flow speed of the air by means of the plural flow speed sensors 55 allows the distribution of the flow rate of the air flowing into the fan for a converter 54 to be estimated. Accordingly, changing the location of the bell mouth 56 in a direction along the rotation axis L on the basis of the measured flow speed of the air allows a pressure loss at the air intake port or the discharging port of the fan for a converter 54 to be surely prevented from increasing.

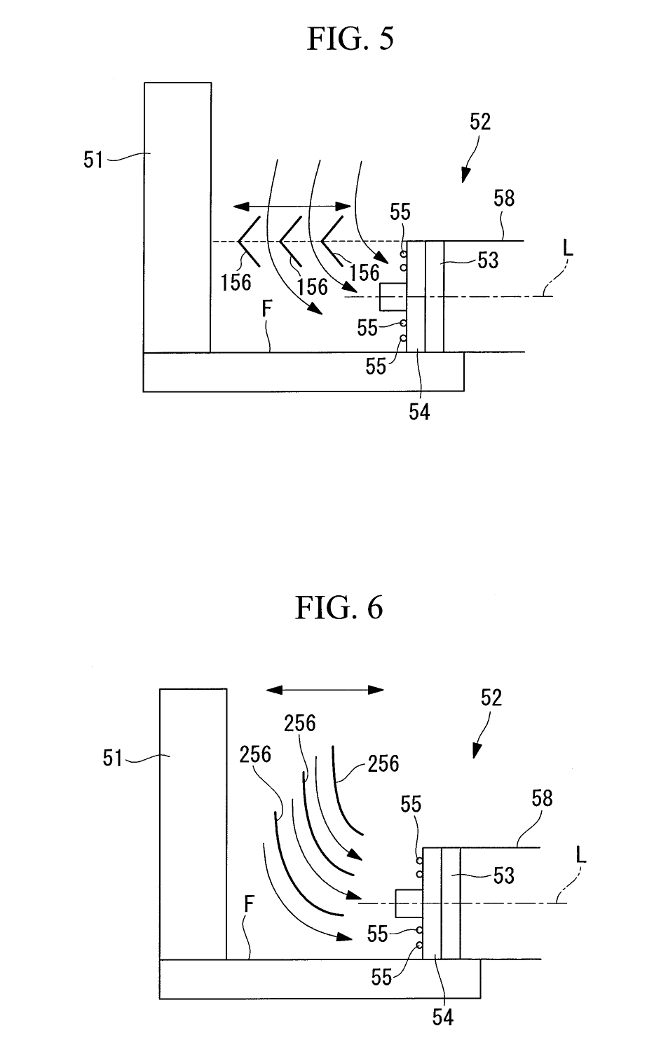

FIG. 5 is a simplified view of the fan unit for a converter in FIG. 3 in accordance with another embodiment.

It may be possible to provide the bell mouth 56 in the fan for a converter 54 to adjust the distribution of the flow rate of the air flowing into the fan for a converter 54 like the above embodiment. It may be also possible to provide a guide (a rectification part) 156 to adjust the distribution of the flow rate of the air flowing into the fan for a converter 54, as shown in FIG. 5. This is not limited specifically.

The guide 156 is a member having a cross section in the approximate shape of an L bent toward the fan for a converter 54, as shown in FIG. 5. The guide 156 is a member extending in a right-and-left direction of the nacelle 3 (a direction vertical to a surface of a sheet of FIG. 5). Furthermore, the guide 156 is movably provided in the direction along the rotation axis L similarly to the bell mouth main body 61.

Changing a location of the guide 156 in the direction along the rotation axis L as described above allows the distribution of the flow rate of the air flowing into the fan for a converter 54 to be adjusted.

FIG. 6 is a simplified view of a fan unit for a converter in FIG. 3 in accordance with further another embodiment.

It may be possible to provide the guide 156 bent into the shape of an L in the fan for a converter 54 to adjust the distribution of the flow rate of the air flowing into the fan for a converter 54 similarly to the above-mentioned embodiment. Moreover, a guide (a rectification part) 256 may be also provided to adjust the distribution of the flow rate of the air flowing into the fan for a converter 54, as shown in FIG. 6. This is not specifically limited.

The guide 256 is a member having a cross section gradually bent toward the fan for a converter 54, as shown in FIG. 6. The guide is a member extending in the right-and-left direction of the nacelle 3 (a direction vertical to a surface of a sheet of FIG. 6). Further, the guide 256 is movably provided in the direction along the rotation axis L similarly to the bell mouth main body 61.

Changing a location of the guide 256 in the direction along the rotation axis L as described above allows a loss coefficient at the flow port of the fan for a converter 54 to be reduced from 1 to 0.3.

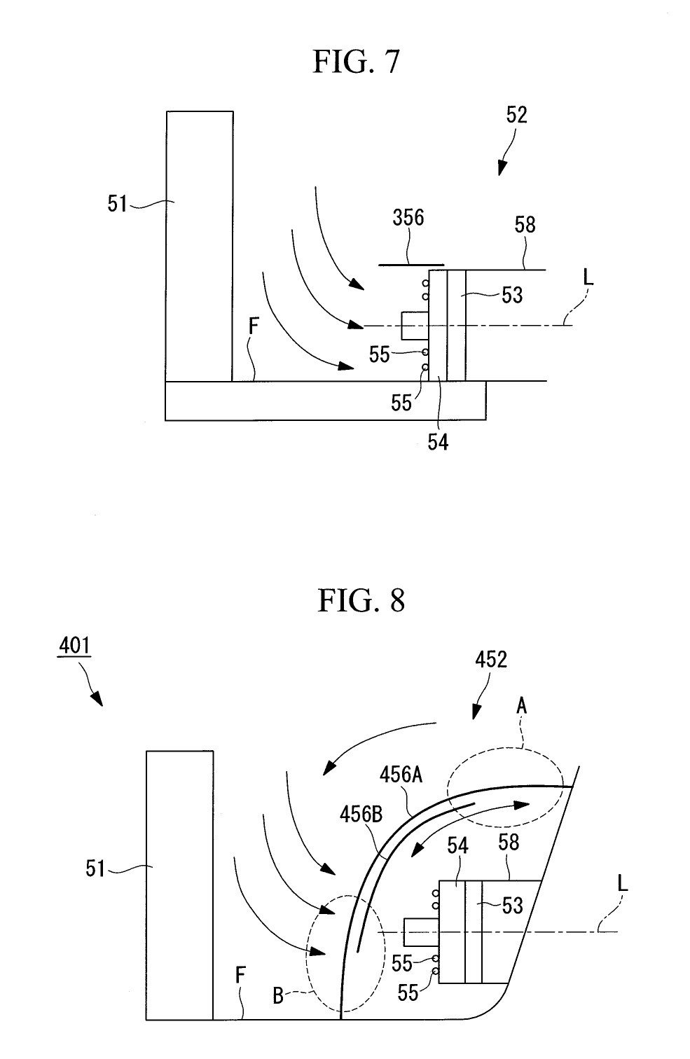

FIG. 7 is a simplified view of the fan unit for a converter in FIG. 3 in accordance with further another embodiment.

It may be possible to provide the bell mouth 56 in the fan for a converter 54 to adjust the distribution of the flow rate of the air flowing into the fan for a converter 54 similarly to the above embodiment. Moreover, a duct (a rectification part) 356 may be also provided as shown in FIG. 7 to adjust the distribution of the flow rate of the air flowing into the fan for a converter 54. This is not specifically limited.

Providing the duct 356 as described above allows a loss coefficient at the flow port of the fan for a converter 54 to be reduced from 1 to 0.5.

### Second Embodiment

Next, Second Embodiment of the invention will be described, with reference to FIGS. 8 to 11.

A basic structure of the wind power generator in accordance with Second Embodiment is similar to that of First Embodiment. Second Embodiment is different from First Embodiment in the structure of the fan unit for a converter. Accordingly, the structure of the fan unit for a converter will only be described in Second Embodiment with reference to FIGS. 8 to 11. Descriptions of other components and such are omitted.

FIG. 8 is a simplified view of a structure of a fan unit for a converter in a wind power generator in accordance with Second Embodiment.

Components same as those of First Embodiment are marked with the same reference signs and numerals and omitted from description.

A fan unit for a converter 452 in a wind power generator 401 comprises the heat exchanger for a converter 53 for circulating the refrigerant for cooling the converter main body 51, the fan for a converter 54 for ventilating the heat exchanger for a converter 53, the plural flow speed sensors 55 for measuring the flow speed of the air flowing into the fan for a converter 54, a first perforated plate (a rectification part) 456A and a second perforated plate (a rectification part) 456B for adjusting the distribution of the flow rate of the air flowing into the fan for a converter 54, and a control part 457 for controlling a location of the second perforated plate 456B, as shown in FIG. 8.

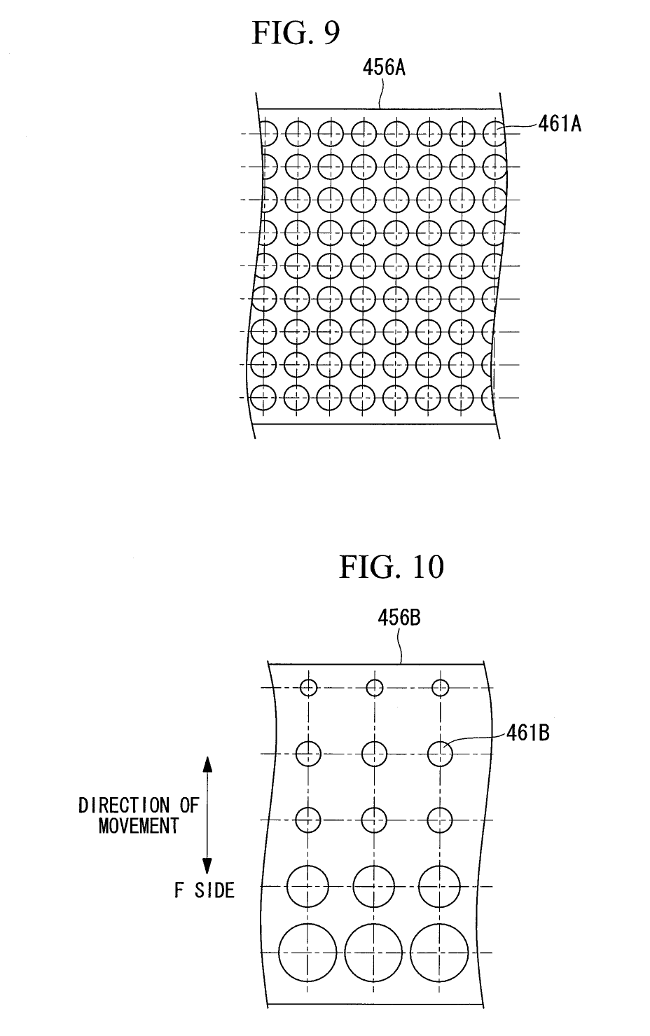

FIG. 9 is a partially enlarged view of a structure of the first perforated plate in FIG. 8.

The first perforated plate 456A is a plate in which plural holes having the same diameter for adjusting the distribution of the flow rate of the air flowing into the fan for a converter 54 together with the second perforated plate 456B are formed. The first perforated plate 456A is arranged to cover the fan for a converter 54 and the heat exchanger for a converter 53 as shown in FIG. 8.

In the first perforated plate 456A, provided in the shape of a lattice are multiple first holes (openings) 461A through which the air flows, as shown in FIG. 9. The plural first holes 461A are formed so as to have a diameter between the maximum diameter and the minimum diameter of later-mentioned second holes 461B.

FIG. 10 is a partially enlarged view of a structure of the second perforated plate in FIG. 8.

The second perforated plate 456B is a belt-shaped plate in which plural holes having different diameters for adjusting the distribution of the flow rate of the air flowing into the fan for a converter 54 together with the first perforated plate 456A are formed. The second perforated plate 456B is movably provided along a surface of the first perforated plate 456A on a fan for a converter 54 side, as shown in FIG. 8.

In the second perforated plate 456B, provided in the shape of a lattice are plural second holes (openings) 461B through which the air flows, as shown in FIG. 10. The second holes 461B are arranged to have a larger diameter to a floor F side.

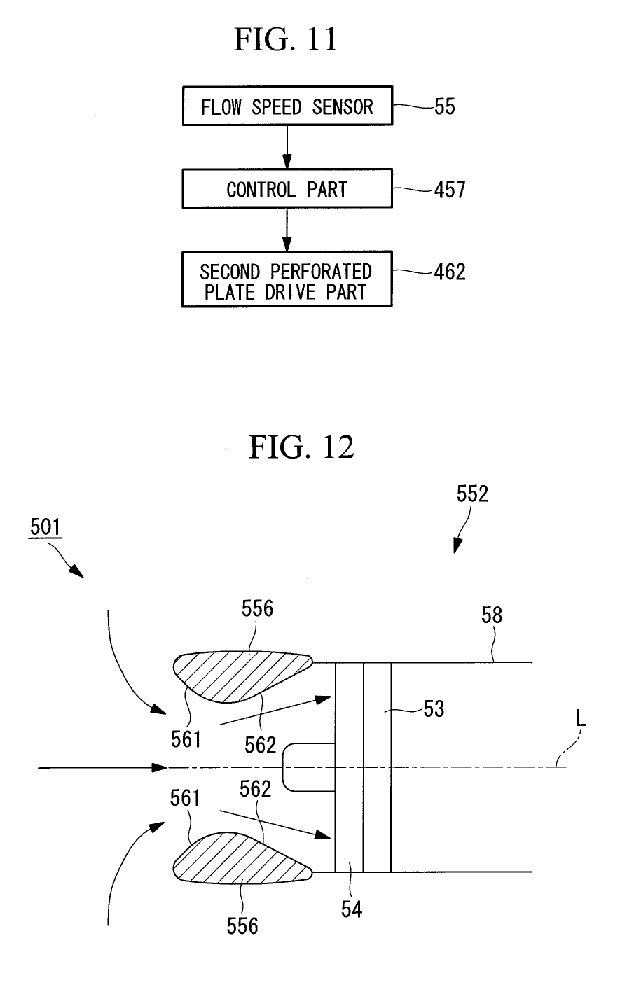

FIG. 11 is a block diagram illustrating a structure of the fan unit for a converter in FIG. 8.

The control part 457 is for controlling the second perforated plate 456B on the basis of output from the flow speed sensors 55 to even the distribution of the flow rate of the air flowing into the fan for a converter 54.

The control part 457 is connected to the flow speed sensors 55 so that flow speed data detected by means of the flow speed sensors 55 would be inputted and is connected to a second perforated plate drive part 462 so that a control signal would be inputted, as shown in FIG. 11.

The second perforated plate drive part 462 is for moving the second perforated plate 456B along the first perforated plate 456A.

Now, described will be a way of adjusting the distribution of the flow rate of the air flowing into the fan for a converter 54, which is a character of Second Embodiment.

The air in the nacelle 3 detours around the converter main body 51 provided in front of the fan for a converter 54, as shown in FIG. 8, when it flows into the fan for a converter 54. In other words, the fan for a converter 54 is provided on the floor F while the converter main body 51 is provided in front of the fan for a converter 54. Accordingly, the air in the nacelle 3 flows from the upper part to an area A along the converter main body 51, and the direction of its flow is changed into a direction along the rotation axis L of the fan for a converter 54 in an area B.

The flow speed of the air flowing into the fan for a converter 54 is detected by means of the plural flow speed sensors 55 and data of the flow speed is inputted to the control part 457, as shown in FIG. 11. The control part 457 estimates the distribution of the flow rate of the air on the basis of the data of the flow speed to control the second perforated plate 456B on the basis of the estimated distribution of the flow rate.

A control signal for moving the second perforated plate 456B to an area A side is outputted to the second perforated plate drive part 462 in order to increase resistance in flow in the area A and reduce resistance in flow in the area B, for example.

The second perforated plate drive part 462 moves the second perforated plate 456B to a position away from the floor F on the basis of the inputted control signal.

This causes the air to pass through only a part where the first holes 461A of the first perforated plate 456A are overlapped with the second holes 461B having smaller diameters in the area A. That is to say, the area the air passes through becomes smaller. Accordingly, the resistance in flow in the area A increases. On the other hand, the resistance in flow in the area B is reduced since there is only the first perforated plate 456A in the area B, that is, because the area where the air passes through becomes larger.

In accordance with the above structure, moving the second perforated plate 456B relatively to the first perforated plate 456A allows the area of the overlap between the first holes 461A of the first perforated plate 456A and the second holes 461B of the second perforated plate 456B to be adjusted to adjust the distribution of the flow rate of the air flowing into the fan for a converter 54. Accordingly, a pressure loss at the air intake port or the discharge port of the fan for a converter 54 can be prevented from increasing.

### Third Embodiment

Next, the Third Embodiment of the invention will be described, with reference to FIG. 12.

A basic structure of the wind power generator in accordance with Third Embodiment is similar to that of First Embodiment. Third Embodiment is different from First Embodiment in the structure of the fan unit for a converter. Accordingly, the structure of the fan unit for a converter will be only described in Third Embodiment with reference to FIG. 12. Descriptions of other components and such are omitted.

FIG. 12 is a simplified view of a structure of a fan unit for a converter in a wind power generator in accordance with Third Embodiment.

Components same as those of First Embodiment are marked with the same reference signs and numerals and omitted from description.

A fan unit for a converter 552 in a wind power generator 501 comprises the heat exchanger for a converter 53 for circulating the refrigerant for cooling the converter main body 51, the fan for a converter 54 for ventilating the heat exchanger for a converter 53, and an exfoliation prevention guide (a rectification part) 556 for adjusting the distribution of the flow rate of the air flowing into the fan for a converter 54, as shown in FIG. 12.

The exfoliation prevention guide 556 is provided at an air flow port of the fan for a converter 54 to prevent exfoliation of a flow of the air flowing into the fan for a converter 54 and to adjust the distribution of the flow speed of the air.

The exfoliation prevention guide 556 comprises a first inclining surface 561, which is an inclining surface approaching the rotation axis L toward the fan for a converter 54, and a second inclining surface 562, which is an inclining surface going away from the rotation axis L toward the fan for a converter 54.

The first inclining surface 561 is provided away from the fan for a converter 54 with respect to the second inclining surface 562. The first inclining surface 561 and the second inclining surface 562 are smoothly connected to each other.

Now, described will be a way of adjusting the distribution of the flow rate of the air flowing into the fan for a converter 54, which is a characteristic of Third Embodiment.

The air flowing into the fan for a converter 54 flows to the fan for a converter 54 along the rotation axis L or the first inclining surface 561, as shown in FIG. 12. The air having flowed along the first inclining surface 561 then flows along the second inclining surface 562 to flow into the fan for a converter 54.

Such a structure contributes to prevent exfoliation of a flow of the air flowing into the fan for a converter 54. This allows a pressure loss at the air intake port or the discharging port of the fan for a converter 54 to be prevented from increasing.

1. A fan unit for a wind power generator having an axial fan for discharging air in a nacelle of the wind power generator to a rear side of the nacelle, the axial fan being provided on a floor of the nacelle, and an equipment of the wind power generator provided in front of the axial fan in a direction of a rotation axis,
the fan unit for a wind power generator comprising a rectification part for adjusting distribution of the flow rate of air flowing into the axial fan.

2. The fan for a wind power generator according to claim 1, comprising plural flow speed sensors for measuring a flow speed of the air flowing into the axial fan, wherein
the rectification part adjusts the distribution of the flow rate of the air on the basis of the flow speed of the air measured by means of the flow speed sensors.

3. The fan for a wind power generator according to claim 2, wherein
the rectification part is a bell mouth and is provided movably in the direction of the rotation axis of the axial fan.

4. The fan for a wind power generator according to claim 2, wherein
the rectification part is a guide for guiding air to the axial fan and is provided movably in the direction of the rotation axis of the axial fan.

5. The fan for a wind power generator according to claim 2, wherein
a first perforated plate provided with holes having approximately the same diameter, the holes evenly distributed, and a second perforated plate provided with holes gradually increasing in diameter in one direction are provided in the rectification part and
the first perforated plate and the second perforated plate relatively move to adjust the distribution of the flow rate of the air flowing into the axial fan.

6. A wind power generator provided in a nacelle with the fan unit for a wind power generator according to claim 1.
